(19) United States
(12) Patent Application Publication
(10) Pub. No.: US 2026/0208889 A1
(43) Pub. Date: Jul. 23, 2026

(54) ORBIT PREDICTION DEVICE AND ORBIT PREDICTION METHOD

(71) Applicants: The University of Osaka, Osaka (JP); Power Laser Technology Inc., Osaka (JP)

(72) Inventors: Kazunori SHIBATA, Osaka (JP); Akifumi YOGO, Osaka (JP); Noriaki MIYANAGA, Osaka (JP)

(21) Appl. No.: 19/451,761

(22) Filed: Jan. 16, 2026

(30) Foreign Application Priority Data
Jan. 21, 2025 (JP) 2025-008713

(51) Int. Cl. B64G 3/00

(52) U.S. Cl. CPC B64G 3/00

(57) ABSTRACT

An orbit prediction device includes: an acquisition section that acquires an initial position and an initial velocity of space debris; a prediction section that, based on the initial position and the initial velocity, predicts a position of the space debris after a predetermined time period; and an error information generation section that generates information on an error range for a predicted position of the space debris after the predetermined time period. Thus, information pertaining to the predicted position of debris is provided in advance in order to appropriately handle the debris.

This Nonprovisional application claims priority under 35 U.S.C. § 119 on Patent Application No. 2025-008713 filed in Japan on Jan. 21, 2025, the entire contents of which are hereby incorporated by reference.

### TECHNICAL FIELD

The present invention relates to an orbit prediction device and an orbit prediction method.

### BACKGROUND ART

The total number and total weight of artificial satellites in orbit are increasing at an accelerating rate. Along with this, space debris (hereinafter referred to as debris) is also increasing. If a cascade of collisions between debris and artificial satellites or between pieces of debris occurs, there is a risk that continuation of space development becomes impossible. Therefore, it is important to artificially reduce debris.

SGP4 (Non-patent Literature 1) and SPOOK (Non-patent Literature 2) are representative software for predicting orbits of artificial satellites or large debris. As methods for improving prediction accuracy, there are methods that use stochastic calculation of time variation (Non-patent Literatures 3 through 5), semi-analytical time evolution (Non-patent Literature 6), optimization of an orbit model using past measurement data (Non-patent Literatures 5 and 7 through 9), machine learning (Non-patent Literature 10), and the like.

### CITATION LIST

### Non-Patent Literature

### [Non-Patent Literature 1]

D. Vallado and P. Crawford. “SGP4 Orbit Determination” Guidance, Navigation, and Control and Co-located Conferences. American Institute of Aeronautics and Astronautics, August 2008

### [Non-Patent Literature 2]

O. R. Fernandez, J. Utzmann, and U. Hugentobler. “Spook—a comprehensive space surveillance and tracking analysis tool” Acta Astronautica, 158:178-184, 2019

### [Non-Patent Literature 3]

Y. Luo and Z. Yang. “A review of uncertainty propagation in orbital mechanics”, Progress in Aerospace Sciences, 89:23-39, 2017

### [Non-Patent Literature 4]

H. Xie, T. Xue, W. Xu, G. Liu, H. Sun, and S. Sun. “Orbital uncertainty propagation based on adaptive gaussian mixture model under generalized equinoctial orbital elements” Remote Sensing, 15(19), 2023

### [Non-Patent Literature 5]

B. Li, J. Sang, and H. Liu. “Accurate propagation of debris orbit error via dynamic calibration and its cataloguing”, Advances in Space Research, 63(8): 2422-2435, 2019

### [Non-Patent Literature 6]

B. Li and J. Sang. “Efficient and accurate error propagation in the semi-analytic orbit dynamics system for space debris”, Advances in Space Research, 65(1): 285-296, 2020

### [Non-Patent Literature 7]

B. Li, J. Sang, and J. Chen. “Achievable orbit determination and prediction accuracy using short-arc space-based observations of space debris”, Advances in Space Research, 62(11): 3065-3077, 2018
[Non-Patent Literature 8]
   J. Sang, B. Li, J. Chen, P. Zhang, and J. Ning. “Analytical representations of precise orbit predictions for earth orbiting space objects”, Advances in Space Research, 59(2): 698-714, 2017

### [Non-Patent Literature 9]

M. Thammawichai and T. Luangwilai. “Data-driven satellite orbit prediction using two line elements”, Astronomy and Computing, 46:100782, 2024

### [Non-Patent Literature 10]

B. Li, J. Huang, Y. Feng, F. Wang, and J. Sang. “A machine learning-based approach for improved orbit predictions of leo space debris with sparse tracking data from a single station”, IEEE Transactions on Aerospace and Electronic Systems, 56(6): 4253-4268, 2020

### SUMMARY OF INVENTION

### Technical Problem

As a method for removing small debris, a method of irradiating debris with laser light to change an orbit of the debris and to cause the debris to enter the atmosphere (laser active debris removal (ADR)) is being studied. In this method, it is necessary to focus laser light having a certain degree of intensity on a size (10 cm or less) of small debris. In a region at an altitude of 800 to 1000 km where much debris exists, debris travels at approximately 7.5 km/s. Even if a position of debris is known accurately at a certain moment, the debris moves as much as 20 m in 2.67 milliseconds in which laser light from the ground travels 800 km. Therefore, a direction for emitting laser light needs to be decided using a predicted orbit.

However, conventional orbit prediction methods are based on the premise that a large amount of orbit data can be acquired in advance, and are difficult to use for small debris for which little orbit data is available. Furthermore, a deviation (prediction error) between the orbit predicted by the conventional orbit prediction methods and an actual orbit is much larger than a size of small debris, and is unknown until the actual orbit is measured. If the prediction error is not known in advance, it is impossible to know whether or not laser light will hit the small debris upon irradiation, and therefore it is impossible to appropriately determine whether or not to emit the laser light.

An object of an aspect of the present invention is to realize an orbit prediction device or an orbit prediction method that can provide in advance information pertaining to a predicted position of debris for appropriately dealing with the debris.

### Solution to Problem

An orbit prediction device in accordance with an aspect of the present invention is configured to include: an acquisition section that acquires an initial position and an initial velocity of space debris; a prediction section that, based on the initial position and the initial velocity, predicts a position of the space debris after a predetermined time period; and an error information generation section that generates information on an error range for a predicted position of the space debris after the predetermined time period.

An orbit prediction method in accordance with an aspect of the present invention causes a computer to carry out: an acquisition step of acquiring an initial position and an initial velocity of space debris; a prediction step of, based on the initial position and the initial velocity, predicting a position of the space debris after a predetermined time period; and an error information generation step of generating information on an error range for a predicted position of the space debris after the predetermined time period.

### Advantageous Effects of Invention

According to an aspect of the present invention, it is possible to provide in advance information pertaining to a predicted position of debris for appropriately dealing with the debris.

### BRIEF DESCRIPTION OF DRAWINGS

FIG. 1 is a block diagram illustrating a configuration of a debris monitoring system in accordance with an embodiment of the present invention.

FIG. 2 is a flowchart illustrating an operation flow of an orbit prediction device.

FIG. 3 is a graph illustrating a relationship between a time t and an upper limit of an error of a predicted position.

### DESCRIPTION OF EMBODIMENTS

### (Debris Monitoring System 1)

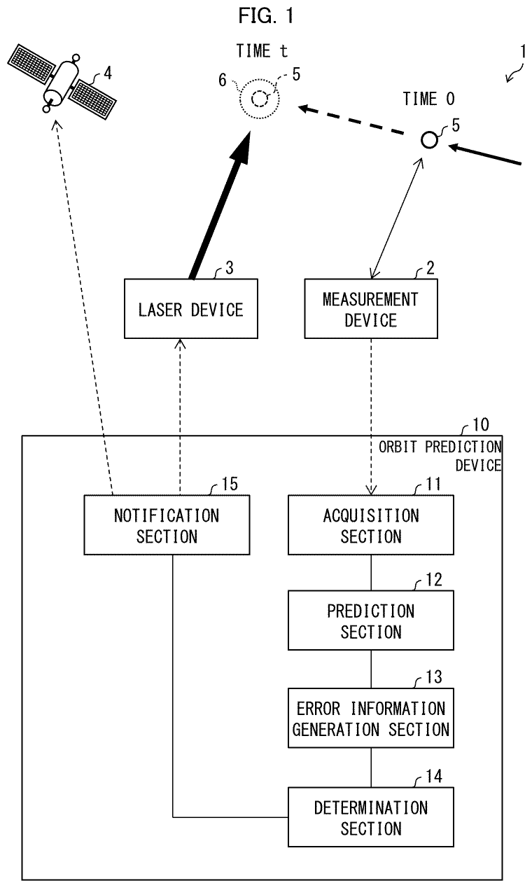

FIG. 1 is a block diagram illustrating a configuration of a debris monitoring system 1 in accordance with the present embodiment. The debris monitoring system 1 includes a measurement device 2, a laser device 3, an artificial satellite 4, and an orbit prediction device 10. The measurement device 2, the laser device 3, and/or the orbit prediction device 10 may be mounted on an artificial satellite, or may be mounted on a ground facility. The measurement device 2, the laser device 3, and/or the orbit prediction device 10 may be mounted on a single artificial satellite, or may be mounted on separate artificial satellites. For example, the measurement device 2 and the orbit prediction device 10 may be mounted on a single artificial satellite, and the laser device 3 may be mounted on a separate artificial satellite. Alternatively, the measurement device 2 and the laser device 3 may be mounted on a single artificial satellite, and the orbit prediction device 10 may be mounted on a ground facility. In FIG. 1, a position of debris 5 at an initial time is depicted by a solid line, and a predicted position of the debris 5 after a predetermined time period is depicted by a dashed line.

The measurement device 2 measures a position of debris (space debris) 5. For example, the measurement device 2 may carry out scanning with a laser beam and measure a distance and a direction to the debris 5 based on a time (TOF) which takes for the laser beam emitted to the debris 5 to return. Small debris is difficult to detect and track from a distance because of the small size thereof. For example, it is impossible to continue to track small debris over one revolution of an orbit thereof around the Earth. Therefore, the measurement device 2 detects the debris 5 that has entered by chance a measurable range of the measurement device 2. The measurement device 2 measures a position of the detected debris 5 multiple times. The measurement device 2 measures an initial position and an initial velocity of the debris 5 at a certain moment (initial time). The initial time is defined as a time 0. For example, the measurement device 2 sets a latest (initial time) measured position of the debris 5 as the initial position, and identifies an initial velocity (a velocity at the initial time) from a change in the measured position. These multiple measurements are carried out before the detected debris 5 exits the measurable range.

The measurement device 2 measures an area-to-mass ratio S_{d}/m_{d} of the debris 5. S_{d} represents a maximum value of a projected area of the debris 5, and m_{d} represents a mass of the debris 5. For example, the measurement device 2 measures a shape and a size of the debris 5, and estimates the area-to-mass ratio S_{d}/m_{d} from the shape and the size. A change in the orbit due to air resistance depends on the area-to-mass ratio S_{d}/m_{d}. Influence of air resistance on the orbit is small. Therefore, the area-to-mass ratio does not need to be accurate, and may be a value estimated as a guideline. The measurement device 2 transmits, to the orbit prediction device 10, information on the initial time, initial position, initial velocity, and area-to-mass ratio of the debris 5.

The laser device 3 causes ablation on the debris 5 by irradiating the debris 5 with laser light. The laser device 3 changes the orbit of the debris 5 by a reaction force from ablation. For example, the debris 5 at a reduced velocity enters an orbit that passes through the Earth's atmosphere, and eventually decelerates and burns up. Although it depends on the distance to the debris 5, a diameter of a laser spot focused by the laser device 3 is assumed to be, for example, approximately 0.5 m to 1 m. The laser device 3 irradiates the debris 5 with laser light based on the predicted position which is of the debris 5 at a future time t and which has been received from the orbit prediction device 10.

The artificial satellite 4 is an artificial satellite that revolves in orbit. The artificial satellite 4 is provided with a propulsion device that controls an orientation and an orbit of the artificial satellite 4. The artificial satellite 4 changes the orbit thereof using the propulsion device to avoid a collision with the debris 5, based on an avoidance instruction from the orbit prediction device 10.

### (Orbit Prediction Device 10)

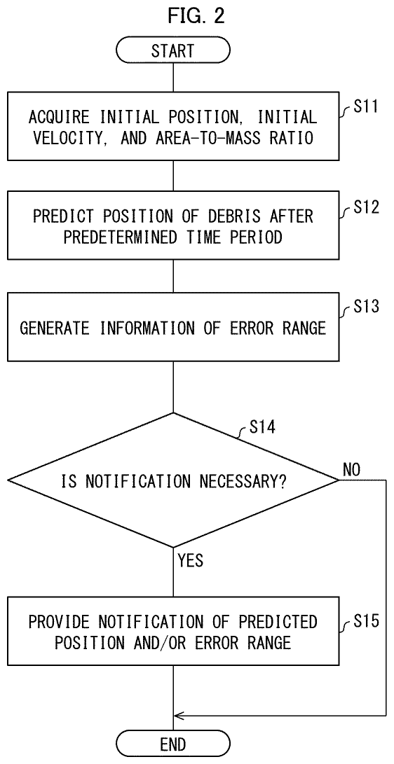

FIG. 2 is a flowchart illustrating an operation flow of the orbit prediction device 10. The orbit prediction device 10 includes an acquisition section 11, a prediction section 12, an error information generation section 13, a determination section 14, and a notification section 15. The orbit prediction device 10 includes a computer.

The acquisition section 11 acquires information on the initial time, initial position, initial velocity, and area-to-mass ratio of the debris 5 from the measurement device 2 (S11). The acquisition section 11 outputs the acquired information on the initial time, initial position, initial velocity, and area-to-mass ratio to the prediction section 12 and the error information generation section 13.

The prediction section 12, based on the initial position and the initial velocity, predicts a position of the debris 5 after a predetermined time period (time t>0) from the initial time (S12). The prediction section 12 predicts the position of the debris 5 at the time t by performing numerical calculation based on an equation of motion for a force which is included in forces acting on the debris 5 and for which numerical calculation can be performed using an equation of motion. The prediction section 12 outputs information on the time t and the predicted position of the debris 5 at the time t to the error information generation section 13 and the determination section 14.

The error information generation section 13 generates information on an error range 6 for the predicted position of the debris 5 after a predetermined time period (at the time t) (S13). The error range 6 here provides an upper limit of an error between the true position (actual position) of the debris 5 after a predetermined time period and the predicted position. The error information generation section 13 specifies an upper limit of an error of the predicted position based on a maximum value of a force which, among forces acting on the debris 5, has not been used for prediction by the prediction section 12. The upper limit of the error depends on a measurement error of the initial position, a measurement error of the initial velocity, and the maximum value of the force which has not been used for prediction by the prediction section 12.

The measurement error of the initial position and the measurement error of the initial velocity depend on performance of the measurement device 2, the distance from the measurement device 2 to the debris 5, and the initial velocity of the debris 5. The measurement error of the initial position and the measurement error of the initial velocity can vary also depending on whether the debris 5 is located in the zenith direction or the horizon direction with respect to the Earth. For example, the error information generation section 13 decides the measurement error of the initial position and the measurement error of the initial velocity based on the initial position and the initial velocity.

The maximum value of a force that has not been used for prediction by the prediction section 12 and that includes a force for which numerical calculation cannot be performed using an equation of motion depends on, for example, the area-to-mass ratio of the debris 5. The error information generation section 13 decides, based on the area-to-mass ratio, the maximum value of the force which has not been used for prediction by the prediction section 12.

For example, the error information generation section 13 specifies the error range 6 after the predetermined time period (at the time t), based on the initial position, the initial velocity, and the area-to-mass ratio. The error information generation section 13 outputs information indicating the specified error range 6 to the determination section 14.

The determination section 14 determines, based on the predicted position of the debris 5 after the predetermined time period and the error range 6, whether or not to provide notification to the laser device 3 or the artificial satellite 4 (S14). The determination section 14 determines, based on the predicted position of the debris 5 after the predetermined time period and the error range 6, whether or not to irradiate the debris 5 with laser light from the laser device 3. In a case where the determination section 14 has determined that the orbit of the debris 5 can be changed by laser light irradiation, the determination section 14 determines to irradiate the debris 5 with laser light. For example, in a case where the predicted position of the debris 5 after the predetermined time period is within an irradiation range of the laser device 3 and the error range 6 falls within the laser spot, the determination section 14 determines to irradiate the debris 5 with laser light, that is, to provide notification to the laser device 3 (Yes in S14). Otherwise, the determination section 14 determines not to irradiate the debris 5 with laser light (No in S14).

The determination section 14 determines, based on the predicted position of the debris 5 after the predetermined time period and the error range 6, whether or not there is a possibility that the debris 5 will collide with the artificial satellite 4. For example, in a case where the distance from the artificial satellite 4 to the error range 6 for the predicted position of the debris 5 after the predetermined time period is not greater than a predetermined criterion, the determination section 14 determines that there is a possibility of collision, that is, determines to provide notification to the artificial satellite 4 (Yes in S14). Otherwise, the determination section 14 determines that there is no possibility of collision (No in S14). The determination section 14 outputs the determination result to the notification section 15.

The notification section 15 provides notification to the laser device 3 and/or the artificial satellite 4, based on the determination result by the determination section 14 (S15). In a case where it has been determined to irradiate the debris 5 with laser light, the notification section 15 notifies the laser device 3 of the predicted position of the debris 5 after the predetermined time period (at the time t) and an instruction to emit laser light.

In a case where it has been determined that there is a possibility that the debris 5 will collide with the artificial satellite 4, the notification section 15 notifies the artificial satellite 4 of an avoidance instruction to avoid a collision with the debris 5 (S15). The avoidance instruction includes information on the predicted position of the debris 5 and the error range after the predetermined time period (at the time t). Note that the notification section 15 may decide, based on the predicted position of the debris 5 and the error range after the predetermined time period (at the time t) and a planned position of the artificial satellite 4 after the predetermined time period (at the time t), a direction and thrust for the artificial satellite 4 to move. In this case, the avoidance instruction includes information on the direction and thrust for the artificial satellite 4 to move.

### (Orbit Prediction and Decision of Error Range)

The following description will discuss methods for predicting an orbit and deciding an error range, which are used by the error information generation section 13. A true position of the debris 5 at the time t is defined as r_{d}(t). An external force (force per unit mass) acting on the debris 5 is defined as F. An equation of motion can be written as follows: r_{d}″=F(r_{d},r_{d}′,t). The prime represents a time derivative. The external force acting on the debris 5 includes an external force whose mathematical formula can be specified and for which a resulting motion can be numerically calculated using an equation of motion, and an external force for which a resulting motion cannot be numerically calculated using an equation of motion. Among the external forces whose mathematical formula can be specified and for which a resulting motion can be numerically calculated using an equation of motion, an external force used by the prediction section 12 to predict an orbit of the debris 5 is defined as F_{NC}. Among the external forces acting on the debris 5, external forces other than F_{NC} are defined as F_{discard}. F=F_{NC}+F_{discard} holds true. In practice, the debris 5 moves under the external force F, and therefore an error occurs in the predicted position obtained using only F_{NC}. A predicted position at the time t which has been predicted by the prediction section 12 by numerical calculation of an equation of motion using only F_{NC} is defined as s(t). s″=F_{NC}(s,s′,t) holds true. An error of the predicted position is |r_{d}(t)−s(t)|.

In order to evaluate a maximum value of an error of a predicted position, three numbers L, M, and A are introduced. For F_{NC}, for which a mathematical formula is known, Lipschitz constants L and M are used. For two arbitrary points (x,x′) and (y,y′) on a phase space, the following holds true for L and M.

$$\vert {F}_{N C} ( x , {x}^{′} ) - {F}_{N C} ( y , {y}^{′} ) \vert \leq L \vert x - y \vert + M \vert {x}^{′} - {y}^{′} \vert$$

Here, L represents an upper limit value of a spatial derivative of F_{NC}. M represents an upper limit value of a velocity derivative of F_{NC}. In a case where A is a maximum value of the external force F_{discard} which is not used by the prediction section 12 for prediction, the following holds true.

$$\vert {F}_{discard} \vert \leq A$$

From this, by introducing U and V as below, a differential inequality for an error |r_{d}(t)−s(t)| of the predicted position and an error |r_{d}′(t)−s′(t)| of the predicted velocity can be derived.

$${r}_{d}^{′} - {s}^{′} = {\int }_{0}^{t} {F}_{NC} ( {r}_{d} , {r}_{d}^{′} , τ ) - {F}_{NC} ( s , {s}^{′} , τ ) d τ + {\int }_{0}^{t} {F}_{discard} ( {r}_{d} , {r}_{d}^{′} , τ ) d τ + {r}_{d}^{′} ( 0 ) - {s}^{′} ( 0 ) . \qquad ( 1 )$$

$$U ( t ) = {\int }_{0}^{t} \vert {r}_{d} - s \vert d τ , V ( t ) = {\int }_{0}^{t} \vert {r}_{d}^{′} - {s}^{′} \vert d τ$$

$${U}^{′} \leq V + {r}_{err} ,$$

$${V}^{′} \leq LU + MV + At + {υ}_{err} ,$$

$$U ( 0 ) = 0 ,$$

$$V ( 0 ) = 0.$$

Here, rₑᵣᵣ is a measurement error of the initial position, and vₑᵣᵣ is a measurement error of the initial velocity. As described below, by using a theorem that bounds a solution of a differential inequality by a solution of a corresponding differential equation, an inequality for the error |r_{d}(t)−s(t)| of the predicted position is obtained.

$$\text{?} = \text{?} + {r}_{err} , \qquad ( 2 )$$

$$\text{?} = L \text{?} + M \text{?} + At + {υ}_{err} ,$$

$$\text{?} ( 0 ) = 0 ,$$

$$\text{?} ( 0 ) = 0.$$

$$U ( t ) \leq \text{?} ( t ) ,$$

$$V ( t ) \leq \text{?} ( t ) .$$

$$\vert {r}_{d} ( t ) - s ( t ) \vert = {U}^{′} ( t ) \leq V ( t ) + {r}_{err} \leq \text{?} ( t ) + {r}_{err}$$

From this, in a case where L>0, the error |r_{d}(t)−s(t)| of the predicted position is expressed by the following formula using L, M, and A.

$$\vert {r}_{d} ( t ) - s ( t ) \vert \leq \frac{A}{L} ( - \frac{{λ}_{-}}{\sqrt{{M}^{2} + 4 L}} {e}^{λ + t} + \frac{{λ}_{+}}{\sqrt{{M}^{2} + 4 L}} {e}^{λ - t} - 1 ) + \frac{{r}_{err}}{\sqrt{{M}^{2} + 4 L}} ( - {λ}_{-} {e}^{λ + t} + {λ}_{+} {e}^{λ - t} ) + \frac{{v}_{err}}{\sqrt{{M}^{2} + 4 L}} ( {e}^{λ + t} - {e}^{λ - t} ) \qquad ( 3 )$$

Here, λ_{±} is as follows:

$${λ}_{\pm } = \frac{M = \sqrt{{M}^{2} + 4 L}}{2} \qquad ( 4 )$$

The formula (3) represents an upper limit of the error of the predicted position. The first term on the right-hand side represents an upper limit of the error of the predicted position due to the external force F_{discard} which is not used by the prediction section 12 for prediction. The second term on the right-hand side represents an upper limit of the error of the predicted position due to the measurement error rₑᵣᵣ of the initial position. The third term on the right-hand side represents an upper limit of the error of the predicted position due to the measurement error vₑᵣᵣ of the initial velocity. By assuming conditions and deciding L, M, and A, an upper limit of the error of the predicted position under the conditions can be obtained.

### Examples of L, M, and A

The following description will discuss a coordinate system that has the center of gravity of the Earth as an origin of spatial coordinates and rotates together with the Earth. An external force F (per unit mass) acting on the debris 5 is expressed as follows.

$$F = {a}_{gra} + {a}_{fic} + {a}_{ast} + {a}_{air} + {a}_{lp} + {a}_{ther} + {a}_{rel} + {a}_{mag}$$

a_{gra} represents the Earth's gravity. a_{fic} represents a fictitious force. aₐₛₜ represents the gravity of other celestial bodies (such as the Sun and the Moon). aₐᵢᵣ represents air resistance. aₗₚ represents light pressure from the Sun and the Earth. aₜₕₑᵣ represents thermal radiation from the debris 5. aᵣₑₗ represents influence of a correction term from general relativity. a_{mag} represents a Lorentz force caused by the Earth's magnetic field. Here, it is assumed that the time from measurement to prediction is one minute or less, and therefore the other forces are negligibly small.

Earth gravitational model 2008 (EGM2008) is adopted for the Earth's gravity. For the Earth's gravity, it is necessary to consider not only the principal term in the form of 1/r but also higher-order terms. An Earth's gravitational potential W_{gra}, including higher-order terms, is expressed as follows.

$${a}_{gra} = - ∇ {W}_{gra} \qquad ( 5 )$$

$${W}_{gra} = - \frac{μ}{r} - μ {\sum }_{n = 2} {\sum }_{m = 0}^{n} ( {C}_{nm} {Ω}_{nm}^{( c )} + {S}_{nm} {Ω}_{nm}^{( s )} )$$

$${Ω}_{nm}^{( c )} = \frac{{a}^{n}}{{r}^{n + 1}} cos m φ {\overline{P}}_{nm} ( cos θ ) ,$$

$${Ω}_{nm}^{( s )} = \frac{{a}^{n}}{{r}^{n + 1}} sin m φ {\tilde{P}}_{nm} ( cos θ ) ,$$

$${C}_{nm} = {\overline{C}}_{nm} + {\hat{C}}_{nm} , {S}_{nm} = {\overline{S}}_{nm} + {\hat{S}}_{nm}$$

$${W}_{n \leq N}^{( NC )} = - \frac{μ}{r} - μ {\sum }_{n = 2}^{N} {\sum }_{m = 0}^{n} ( {\overline{C}}_{nm} {Ω}_{nm}^{( c )} + {\overline{S}}_{nm} {Ω}_{nm}^{( s )} ) ,$$

$${W}_{n \geq N + 1}^{( disc )} = - μ {\sum }_{n = N + 1} {\sum }_{m = 0}^{n} ( {\overline{C}}_{nm} {Ω}_{nm}^{( c )} + {\overline{S}}_{nm} {Ω}_{nm}^{( s )} ) ,$$

$${\hat{W}}^{( disc )} = - μ {\sum }_{n = 2} {\sum }_{m = 0}^{n} ( {\hat{C}}_{nm} {Ω}_{nm}^{( c )} + {\hat{S}}_{nm} {Ω}_{nm}^{( s )} ) .$$

Here, μ=3.986×10¹⁴ m³/s² represents the geocentric gravitational constant, a=6378 km represents the Earth's radius, Pₙₘ⁻ represents a normalized Legendre function, θ represents a zenith angle, and φ represents an azimuth angle. Cₙₘ and Sₙₘ represent contributions of higher-order terms and depend on the gravitational field model. n represents a degree. Cₙₘ and Sₙₘ depend on time. Cₙₘ and Sₙₘ can be classified into time-independent parts Cₙₘ⁻ (bar) and Sₙₘ⁻ (bar), and time-dependent parts Cₙₘ\hat{ } (hat) and Sₙₘ\hat{ } (hat). In a case where higher-order terms of the Earth's gravitational potential are used for the prediction calculation, the accuracy of the predicted position becomes higher but the calculation time for the prediction becomes longer.

The external force F_{NC} used for prediction includes the principal term and terms W_{n≤N}^{(NC)} up to the N-th degree of the Earth's gravitational potential. The external force F_{discard} which is not used for prediction includes terms W_{n≥N+1}^{(disc)} of a degree higher than N of the Earth's gravitational potential and a time-dependent term W\hat{ }^{(disc)}. \hat{ }represents a hat.

$${a}_{gra} = {W}_{n \leq N}^{( NC )} + {W}_{n \geq N + 1}^{( disc )} + W {\hat{}}^{( disc )}$$

The time-dependent term W\hat{ }^{(disc)} of the Earth's gravitational potential is a term due to tides and variations in mass distribution.

The fictitious force a_{fic} is represented as follows.

$${a}_{fic} = - ω \times ( ω \times r ) - 2 ω \times {r}^{′} - {ω}^{′} \times r + {b}_{fic} \qquad ( 6 )$$

ω (boldface) represents a vector of the Earth's axis. A magnitude thereof is the angular velocity ω=7.29×10⁻⁵ rad/s of the Earth's rotation. In the formula (6), the first three terms on the right-hand side are a centrifugal force, a Coriolis force, and an Euler force, respectively. b_{fic} is a term caused by deformation of the Earth. The external force F_{NC} used for prediction includes the centrifugal force and the Coriolis force. The Euler force and b_{fic} are very small and are thus ignored.

The external force F_{NC} which is used for prediction and the external force F_{discard} which is not used for prediction are represented as follows.

$${F}_{NC} = - ∇ {W}_{n \leq N}^{( NC )} - ω \times ( ω \times r ) - 2 ω \times {r}^{′} . \qquad ( 7 )$$

$${F}_{discard} = - ∇ {W}_{n \geq N + 1}^{( disc )} - ∇ {\hat{W}}^{( disc )} + {g}_{disc}$$

$${g}_{disc} = {a}_{ast} + {a}_{air} + {a}_{lp} + {a}_{ther} + {a}_{rel} + {a}_{mag}$$

Influence aᵣₑₗ due to the correction term of general relativity and a Lorentz force a_{mag} due to the Earth's magnetic field are very small and can thus be ignored.

The following hold true, respectively, for the centrifugal force and the Coriolis force included in F_{NC}.

$$\vert - ω \times ( ω \times x ) - [ - ω \times ( ω \times y ) ] \vert \leq {ω}^{2} \vert x - y \vert \qquad ( 8 )$$

$$\vert - 2 ω \times {x}^{′} - ( - 2 ω \times {y}^{′} ) \vert \leq 2 ω \vert {x}^{′} - {y}^{′} \vert$$

Therefore, ω² is included as a term in L, and 20 is included as a term in M. The following holds true for −∇W_{n≤N}^{(NC)}.

$$\vert - ∇ {W}_{n \leq N}^{( NC )} ( x ) - [ - ∇ {W}_{n \leq N}^{( NC )} ( y ) ] \vert \leq 2 \sqrt{3} \frac{μ}{{r}_{400}^{3}} ( 1 + {Δ}_{N} ) \vert x - y \vert \qquad ( 9 )$$

Here, r₄₀₀=6.778×10³ km is a distance from the Earth's center of gravity to an altitude of 400 km. Δ_{N} represents influence of higher-order terms (2≤n≤N) in W_{n≤N}^{(NC)}. Δ_{N} is defined as follows.

$${\sum }_{m = 0}^{n} ( \vert {\overline{C}}_{nm} \vert \vert ∇ {\partial }_{j} {Ω}_{nm}^{( c )} \vert + \vert {\overline{S}}_{nm} \vert \vert ∇ {\partial }_{j} {Ω}_{nm}^{( s )} \vert ) \leq \frac{2}{{r}_{400}^{3}} {ℓ}_{j , n} \qquad ( 10 )$$

$$\vert ∇ {f}_{j} \vert = \vert ∇ {\partial }_{j} {W}_{n \leq N}^{( NC )} \vert \leq \frac{2 μ}{{r}_{400}^{3}} ( 1 + {\sum }_{n = 2}^{N} {ℓ}_{j , n} )$$

$$\sqrt{{\sum }_{j = 1}^{3} max {\vert ∇ {f}_{j} \vert}^{2}} = \frac{2 μ}{{r}_{400}^{3}} \sqrt{{\sum }_{j = 1}^{3} {( 1 + {\sum }_{n = 2}^{N} {ℓ}_{j , n} )}^{2}} = 2 \sqrt{3} \frac{μ}{{r}_{400}^{3}} ( 1 + {Δ}_{N} )$$

Here, Cₙₘ⁻ (bar) and Sₙₘ⁻ (bar) represent time-independent parts of Cₙₘ and Sₙₘ, respectively.

From the formulae (8) and (9), L and M are given as follows.

$$L = 2 \sqrt{3} \frac{μ}{{r}_{400}^{3}} ( 1 + {Δ}_{N} ) + {ω}^{2} , \qquad ( 11 )$$

$$M = 2 ω .$$

Δ_{N} depends on a maximum degree N used for prediction among the higher-order terms of the Earth's gravity. That is, Δ_{N} is decided once the maximum degree N used for prediction is decided.

### (Decision of A)

Next, the upper limit A of |F_{discard}| is calculated. From the formula (7), the following holds true.

$$\vert {F}_{discard} \vert \leq \vert ∇ {W}_{n \geq N + 1}^{( disc )} \vert + \vert ∇ W {\hat{}}^{( disc )} \vert + \vert {g}_{disc} \vert$$

The upper limit A can be obtained by calculating each term on the right-hand side.

|∇W_{n≥N+1}^{(disc)}| is obtained as follows.

$$\vert ∇ {W}_{n \geq N + 1}^{( disc )} \vert = μ \vert ∇ {\sum }_{n = N + 1} {\sum }_{m = 0}^{n} ( {\overline{C}}_{nm} {Ω}_{nm}^{( c )} + {\overline{S}}_{nm} {Ω}_{nm}^{( s )} ) \vert \leq μ {\sum }_{n = N + 1} {\sum }_{m = 0}^{n} ( \vert {\overline{C}}_{nm} \vert \vert ∇ {Ω}_{nm}^{( c )} \vert + \vert {\overline{S}}_{nm} \vert \vert ∇ {Ω}_{nm}^{( s )} \vert ) \qquad ( 12 )$$

$$F = {( n + 1 )}^{2} {{\overline{P}}_{nm} ( cos θ )}^{2} + {[ {\partial }_{θ} {\overline{P}}_{nm} ( cos θ ) ]}^{2} ,$$

$$G = \frac{{m}^{2}}{{sin}^{2} θ} {{\overline{P}}_{nm} ( cos θ )}^{2} ,$$

$$\vert {\overline{C}}_{nm} \vert \vert ∇ {Ω}_{nm}^{( c )} \vert + \vert {\overline{S}}_{nm} \vert \vert ∇ {Ω}_{nm}^{( s )} \vert = \frac{{a}^{n}}{{r}^{n + 2}} ( \vert {\overline{C}}_{nm} \vert \sqrt{F {cos}^{2} m φ + G {sin}^{2} m φ} + \vert {\overline{S}}_{nm} \vert \sqrt{F {sin}^{2} m φ + G {cos}^{2} m φ} ) .$$

$$\vert {\overline{C}}_{nm} \vert \vert ∇ {Ω}_{nm}^{( c )} \vert + \vert {\overline{S}}_{nm} \vert \vert ∇ {Ω}_{nm}^{( s )} \vert \leq \frac{{a}^{n}}{{r}^{n + 2}} {J}_{nm}$$

$${A}_{1} ( N ) = \frac{μ}{{r}_{400}^{2}} {\sum }_{n = N + 1} {( \frac{a}{{r}_{400}} )}^{n} {\sum }_{m = 0}^{n} {J}_{nm}$$

$$\vert ∇ {W}_{n \geq N + 1}^{( disc )} \vert \leq {A}_{1} ( N )$$

Here, Jₙₘ, which appears midway, represents a maximum value of a term related to φ.

In regard to |∇W\hat{ }^{(disc)}|, magnitudes of Cₙₘ\hat{ } and Sₙₘ\hat{ } are considered to be equivalent to the standard deviation of data of EGM2008. By a calculation similar to the formula (12), it is possible to estimate as follows.

$$\vert ∇ {W}^{∧ ( disc )} \vert \leq 1.118 \times {10}^{- 5} m / {s}^{2}$$

An upper limit is decided for each term of g_{disc}.

(Gravity aₐₛₜ of Other Celestial Bodies)

The gravity aₐₛₜ of other celestial bodies mainly includes the gravity of the Sun and the gravity of the Moon as forces whose influence cannot be ignored. A maximum value of the Sun's gravity as can be estimated as follows.

$$\vert {a}_{s} \vert \leq 2 \frac{{μ}_{s}}{{R}_{e}^{3}} r [ 1 + \frac{3}{2} γ + 3 γ ( 1 + \frac{5}{4} γ + \frac{5}{16} {γ}^{2} ) ( 1 + γ ) ] \qquad ( 13 )$$

Here, μₛ=1.327×10²⁰ m³/s² is the Sun's gravitational constant (a product of a mass and the universal gravitational constant), Rₑ is a distance from the center of the Sun to the Earth's center of gravity, r is a distance from the Earth's center of gravity to the debris 5, and γ is r/Rₑ. Assuming that a maximum altitude of the debris 5 from the Earth's surface is 500 km, r=r₅₀₀=6.878×10³ km, and Rₑ≥1.471×10⁸ km, the maximum value of the Sun's gravity as is as follows.

$$\vert {a}_{s} \vert < 5.737 \times 1 {0}^{- 7} m / {s}^{2}$$

A maximum value of the gravity of the Moon can also be estimated in a similar manner. In the formula (13), in a case where: the gravitational constant μₘ of the Moon is 4.903×10¹² m³/s²; a distance Rₘ from the Earth's center of gravity to the center of the Moon is not less than 3.564×10⁵ km; and γ is r/Rₘ, the maximum value of the gravity aₘ of the Moon is as follows.

$$\vert {a}_{m} \vert < 1.624 \times 1 {0}^{- 6} m / {s}^{2}$$

The gravity of planets is negligible because such gravity is three or more orders of magnitude smaller than the gravity of the Sun and the gravity of the Moon.

$$\vert {a}_{a s t} \vert \leq \vert {a}_{s} \vert + \vert {a}_{m} \vert < 2.197 \times 1 {0}^{- 6} m / {s}^{2}$$

Thus, it is possible to estimate a maximum value of the gravity aₐₛₜ of other celestial bodies as described above.

(Air Resistance aₐᵢᵣ)

The air resistance aₐᵢᵣ is given as follows, according to a widely-used model.

$${a}_{a i r} = - \frac{1}{2} {ρC}_{D} \frac{{S}_{d}}{{m}_{d}} {v}_{a i r} {v}_{a i r} \qquad ( 14 )$$

Here, ρ represents an air density, C_{D} represents a non-dimensional drag coefficient, and vₐᵢᵣ represents an air-relative velocity. A typical range of C_{D} is from 2 to 4. Here, C_{D} is 4. A maximum value of air density at the altitude of 400 km is defined as follows: ρ=7.49×10⁻¹² kg/m³. A wind velocity at the altitude of 400 km is at most several hundred meters per second. Therefore, vₐᵢᵣ is defined as a velocity of the debris 5 (a velocity in a circular orbit at the altitude of 400 km) as follows:

$${{v}_{a i r}}^{2} \approx μ / {r}_{400} = 58.8 \; 07 {km}^{2} / {s}^{2} .$$

$$\vert {a}_{a i r} \vert < 8.809 \times 1 {0}^{- 5} m / {s}^{2}$$

Thus, it is possible to estimate a maximum value of the air resistance aₐᵢᵣ as described above.

(Light Pressure aₗₚ)

A light pressure a_{lp,s} of solar radiation is modeled as follows.

$${a}_{{l}_{p , s}} = - \frac{{Q}_{s} cos {θ}_{s}}{c} \frac{{S}_{d}}{{m}_{d}} [ 2 ( \frac{δ}{3} + {ρ}_{s} cos {θ}_{s} ) n + ( 1 - {ρ}_{s} ) ℓ ] \qquad ( 15 )$$

Here, Qₛ represents a radiation flux from the Sun, θₛ represents an angle between a normal direction and a direction toward the Sun, c represents a light velocity, δ represents a diffuse reflectance, ρₛ represents a specular reflectance, n represents a normal vector, and l represents an incidence vector from a light source. The small debris 5 is assumed to have a shape and a size like a coin, and it is assumed that the area-to-mass ratio is as follows: S_{d}/m_{d}<0.1 m²/kg. The normal line is a normal line of a principal plane (a plane on which a projected area is maximum) of the debris 5.

The forces due to solar radiation reflected from the Earth (albedo) and infrared radiation from the Earth are modeled in the same form. Therefore, a combination of these light pressures is as follows.

$$\vert {a}_{lp} \vert \leq \frac{8 Q}{3 c} \frac{{S}_{d}}{{m}_{d}} . \qquad ( 16 )$$

Here, Q represents a radiation flux of a sum of solar radiation, the Earth's albedo, and the Earth's infrared radiation. At mean distance, solar radiation flux is approximately 1367.7 W/m² and a variation thereof is =40.6 W/m². Similarly, a mean radiation flux due to the Earth's albedo is approximately 465 W/m², and a radiation flux due to infrared radiation is 232 W/m². From these, Q is at most 1367.7+40.6+465+232=2105.2 W/m². Under this condition, from the formula (16), the following holds true.

$$\vert {a}_{lp} \vert < 1.873 \times 1 {0}^{- 6} m / {s}^{2}$$

Thus, it is possible to estimate a maximum value of the light pressure aₗₚ as described above.

(Thermal Radiation aₜₕₑᵣ)

The thermal radiation aₜₕₑᵣ from the debris 5 is given as follows.

$${a}_{ther} = - \frac{2 {Q}_{ther}}{3 c} \frac{{S}_{d}}{{m}_{d}} n \qquad ( 17 )$$

$${Q}_{t h e r} = εσ {T}^{4}$$

Here, Qₜₕₑᵣ represents a flux of thermal radiation, T represents a temperature, σ=5.67×10⁻⁸ W/(m²K⁴) represents a Stefan-Boltzmann constant, ε represents a surface emissivity, and n represents a normal vector of the surface. From a temperature model of debris, T≤414 K is obtained. Under this condition, from the formula (17), the following holds true.

$$\vert {a}_{ther} \vert < 3.704 \times 1 {0}^{- 7} m / {s}^{2}$$

Thus, it is possible to estimate a maximum value of the thermal radiation aₜₕₑᵣ as described above.

### (Maximum Value of Error of Predicted Position)

By summing up the upper limit values of these forces, a maximum value of g_{disc} can be estimated as follows.

$$\vert {g}_{disc} \vert \leq 9.253 \times 1 {0}^{- 5} m / {s}^{2}$$

95% of g_{disc} is air resistance, and the air resistance has a largest contribution. A contribution of the gravity of the Sun and the gravity of the Moon is 2.5% of the air resistance. Therefore, the gravity of the Sun and the gravity of the Moon do not need to be used for orbit prediction. From the above, an upper limit value A of the external force F_{discard} which is not used for prediction can be estimated as follows.

$$A = {A}_{l} ( N ) + 1.038 \times 1 {0}^{- 4} m / {s}^{2}$$

A₁(N) depends on a maximum degree N used for prediction among the higher-order terms of the Earth's gravity. That is, A₁(N) is decided once the maximum degree N used for prediction is decided. Once Nis decided, L and M are also decided. A part where r₄₀₀ is used on the assumption of an altitude of 400 km may be decided in accordance with an altitude of the debris 5 or a measurement range of the measurement device 2. From the above, once the upper limit of the area-to-mass ratio S_{d}/m_{d} of the debris 5 and N are decided, it is possible to obtain L, M, and A as constants. From the formula (3), once L, M, A, the measurement error rₑᵣᵣ of the initial position, and the measurement error vₑᵣᵣ of the initial velocity are decided, it is possible to specify an upper limit of the error |r_{d}(t)−s(t)| of the predicted position.

The error information generation section 13 may be notified from the prediction section 12 of the maximum degree N used by the prediction section 12 for prediction, or may decide the maximum degree N in advance. The error information generation section 13 may assume in advance an upper limit of the area-to-mass ratio S_{d}/m_{d}, or may decide the upper limit based on information on the area-to-mass ratio obtained from the measurement device 2. The error information generation section 13 specifies an upper limit of the error |r_{d}(t)−s(t)| of the predicted position after a predetermined time period (at the time t), from the formula (3) using L, M, A, rₑᵣᵣ, and vₑᵣᵣ. The error information generation section 13 generates information on an error range indicating the upper limit of the error |r_{d}(t)−s(t)| of the predicted position after the predetermined time period (at the time t).

The error range 6 specified by the error information generation section 13 in this manner indicates an upper limit of an error which is not exceeded, as long as the conditions assumed when estimating the maximum values of the respective forces are satisfied. This is information that cannot be obtained by any method which uses conventional stochastic calculation, estimation based on past measurement data, or the like. Therefore, for example, in a case where the error range 6 falls within a laser spot generated by the laser device 3, the determination section 14 can determine that laser light will reliably hit the debris 5 by irradiating the debris 5 at the predicted position with the laser light. The orbit prediction device 10 can provide reliable information indicating a degree to which the artificial satellite 4 is to be moved in order to avoid a collision with the debris 5.

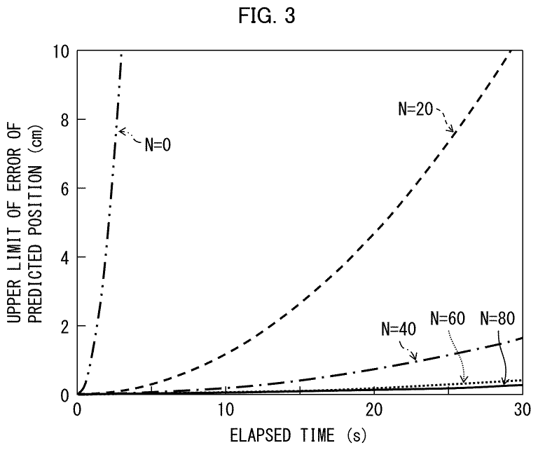

FIG. 3 is a graph illustrating a relationship between the time t and an upper limit of an error of a predicted position. The horizontal axis represents an elapsed time (time t) from the initial time, and the vertical axis represents an upper limit of an error of a predicted position. In FIG. 3, the upper limit of the error of the predicted position is depicted for a plurality of cases in which the maximum degree N used for prediction is changed. Here, rₑᵣᵣ and vₑᵣᵣ are set to 0. For example, it can be seen that, in a case where the maximum degree N is not less than 40, an upper limit of an error (an error due to an external force which is not used for prediction) of a predicted position after 30 seconds can be suppressed to 2 cm or less.

As can be seen from the formula (3), the upper limit of the error |r_{d}(t)−s(t)| of the predicted position diverges exponentially by the time t. Therefore, the upper limit of the error of the predicted position obtained by the formula (3) is divergent in a long time such as several hours or one day or more in which the debris 5 revolves around the Earth, and such an upper limit is not practically useful. Meanwhile, it is difficult to continue to track, by observation, small debris 5 that revolves at a distance from the measurement device 2. Therefore, it is necessary to handle the debris 5 before the debris 5 detected by chance exits the observation range.

The debris monitoring system 1 in accordance with the present embodiment is effective to handle the debris 5 before the debris 5 that has entered the measurement range of the measurement device 2 exits the measurement range of the measurement device 2 or the irradiation range of the laser device 3. The orbit prediction device 10 generates, in a short period of time (for example, 1 minute or less, or at most several minutes) until the debris 5 exits the measurement range or the irradiation range, information on the error range 6 which is accurate and useful. The orbit prediction device 10 generates information on the predicted position of the debris 5 and the error range 6 at the time t before the debris 5 exits the measurement range or the irradiation range. The laser device 3 can irradiate the debris 5 with laser light based on the position predicted by the orbit prediction device 10 before the debris 5 exits the irradiation range. The orbit prediction device 10 can cause the artificial satellite 4 to change the orbit based on the predicted position and the error range 6 before the debris 5 collides with the artificial satellite 4. Thus, the orbit prediction device 10 can provide in advance the laser device 3 or the artificial satellite 4 with information pertaining to the predicted position for appropriately dealing with debris.

The measurement error rₑᵣᵣ of the initial position and the measurement error vₑᵣᵣ of the initial velocity can depend on the initial position and/or the initial velocity of the debris 5. For example, the error information generation section 13 changes the measurement error rₑᵣᵣ of the initial position and the measurement error vₑᵣᵣ of the initial velocity in accordance with a distance from the measurement device 2 to the debris 5. Alternatively, the error information generation section 13 changes the measurement error rₑᵣᵣ of the initial position and the measurement error vₑᵣᵣ of the initial velocity in accordance with the initial position of the debris 5 with respect to the Earth. Depending on the characteristics of the measurement device 2, there may be a case where measurement errors in the vertical and horizontal directions orthogonal to the depth direction are larger than a measurement error of the position in the depth direction as viewed from the measurement device 2. That is, the measurement errors of the initial position and the initial velocity may vary depending on the moving direction (velocity) of the debris 5. The error information generation section 13 changes, in accordance with the initial velocity, the measurement error rₑᵣᵣ of the initial position and the measurement error vₑᵣᵣ of the initial velocity. The error information generation section 13 specifies different error ranges in accordance with the initial position and/or the initial velocity of the debris 5.

The maximum value A of a force which has not been used for prediction by the prediction section 12 and which includes the air resistance aₐᵢᵣ and the like depends on the area-to-mass ratio S_{d}/m_{d} of the debris 5. The error information generation section 13 changes the maximum value A in accordance with the area-to-mass ratio S_{d}/m_{d} of the debris 5, and calculates the error range using the changed maximum value A. Therefore, the error information generation section 13 specifies different error ranges in accordance with the area-to-mass ratio S_{d}/m_{d} of the debris 5.

### (Variation)

The prediction section 12 and the error information generation section 13 may generate predictions and error ranges of predicted positions at different times for a single piece of debris. The prediction section 12 and the error information generation section 13 may generate information on predictions and error ranges of predicted positions for a single piece of debris multiple times, using initial positions and initial velocities at different times. For example, the debris monitoring system 1 may carry out prediction again as time passes in order to continue monitoring whether the debris 5 will collide with the artificial satellite 4.

In a case where an upper limit of an error of the predicted position specified by the error information generation section 13 is not less than a predetermined value, the error information generation section 13 may instruct the prediction section 12 to increase the maximum degree N used for prediction. For example, the error information generation section 13 may change the maximum degree N used for prediction until the error range falls within a laser spot.

The error information generation section 13 may assume in advance a maximum area-to-mass ratio in accordance with assumed debris 5 without obtaining information on an area-to-mass ratio of debris 5 from the measurement device 2, and may use the assumed area-to-mass ratio. For example, the error information generation section 13 may decide in advance, based on the assumed area-to-mass ratio, the maximum value A of a force which has not been used for prediction.

The error information generation section 13 may decide in advance, in accordance with characteristics of the measurement device 2, the measurement error rₑᵣᵣ of the initial position and the measurement error vₑᵣᵣ of the initial velocity.

The prediction section 12 may use, for example, the gravity of the Moon to predict a position of the debris 5. In this case, the error information generation section 13 can subtract influence of the gravity of the Moon from the maximum value A of the force which has not been used for prediction. For example, in a case where the gravity of the Moon is included in prediction, the upper limit of the error of the predicted position is reduced by approximately 20% (where N=60), as compared with a case where the gravity of the Moon is not included in prediction. Similarly, the prediction section 12 may use, for example, the gravity of the Sun to predict a position of the debris 5.

The measurement device 2, the laser device 3, and/or the orbit prediction device 10 may be mounted on the artificial satellite 4. Only a part of the orbit prediction device 10 may be mounted on the laser device 3 or the artificial satellite 4. For example, the determination section 14 may be mounted on the laser device 3 or the artificial satellite 4. In this case, the orbit prediction device 10 transmits information on the predicted position of the debris 5 and the error range 6 after a predetermined time period to the laser device 3 or the artificial satellite 4.

In a case where the orbit prediction device 10, in particular, the prediction section 12 is provided in a ground facility, it is possible to carry out high-load numerical calculation using a higher-performance computer. Therefore, it is possible to include higher-order terms of the Earth's gravity in calculation of position prediction.

### Software Implementation Example

Functions of the orbit prediction device 10 (hereinafter referred to as a “device”) can be realized by a program for causing a computer to function as the device, the program causing the computer to function as control blocks (in particular, the acquisition section 11, the prediction section 12, the error information generation section 13, the determination section 14, and the notification section 15) of the device.

In this case, the device includes, as hardware for executing the program, a computer including at least one control device (e.g., a processor) and at least one storage device (e.g., a memory). The functions described in the above embodiments are realized by the program being executed by the at least one control device and the at least one storage device.

The program may be recorded in one or more non-transitory computer-readable recording media. The recording media may be included in the device or need not be included in the device. In the latter case, the program may be supplied to the device via any wired or wireless transmission medium.

Furthermore, some or all of functions of the control blocks can also be realized by a logic circuit. For example, the present invention encompasses, in its scope, an integrated circuit in which a logic circuit that functions as each of the above-described control blocks is formed. In addition, the function of each of the control blocks can be realized by, for example, a quantum computer.

Aspects of the present invention can also be expressed as follows:

The orbit prediction device in accordance with a first aspect of the present invention is configured to include: an acquisition section that acquires an initial position and an initial velocity of space debris; a prediction section that, based on the initial position and the initial velocity, predicts a position of the space debris after a predetermined time period; and an error information generation section that generates information on an error range for a predicted position of the space debris after the predetermined time period.

The orbit prediction device in accordance with a second aspect of the present invention may be configured so that, in the first aspect, the information on the error range indicates an upper limit of an error of the predicted position.

The orbit prediction device in accordance with a third aspect of the present invention may be configured so that, in the first or second aspect, the error information generation section specifies different error ranges in accordance with the initial position.

The orbit prediction device in accordance with a fourth aspect of the present invention may be configured so that, in any of the first through third aspects, the acquisition section acquires an area-to-mass ratio of the space debris; and the error information generation section specifies different error ranges in accordance with the area-to-mass ratio.

The orbit prediction device in accordance with a fifth aspect of the present invention may be configured so that, in the fourth aspect, the error information generation section changes, in accordance with the area-to-mass ratio, a maximum value A of a force which has not been used for prediction by the prediction section among the forces acting on the space debris, and calculates the error range using the maximum value A which has been changed.

The orbit prediction device in accordance with a sixth aspect of the present invention may be configured so that, in the third aspect, the error information generation section decides different error ranges in accordance with a distance between the space debris and a measurement device which has measured the initial position and the initial velocity.

The orbit prediction device in accordance with a seventh aspect of the present invention may be configured so that, in the third aspect, the error information generation section decides different error ranges in accordance with the initial position with respect to the Earth.

The orbit prediction method in accordance with an eighth aspect of the present invention causes a computer to carry out: an acquisition step of acquiring an initial position and an initial velocity of space debris; a prediction step of, based on the initial position and the initial velocity, predicting a position of the space debris after a predetermined time period; and an error information generation step of generating information on an error range for a predicted position of the space debris after the predetermined time period.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Debris monitoring system
2: Measurement device
3: Laser device
4: Artificial satellite
5: Debris
6: Error range
10: Orbit prediction device
11: Acquisition section
12: Prediction section
13: Error information generation section
14: Determination section
15: Notification section

1. An orbit prediction device, comprising:
an acquisition section that acquires an initial position and an initial velocity of space debris;
a prediction section that, based on the initial position and the initial velocity, predicts a position of the space debris after a predetermined time period; and
an error information generation section that generates information on an error range for a predicted position of the space debris after the predetermined time period.

2. The orbit prediction device as set forth in claim 1, wherein:
the information on the error range indicates an upper limit of an error of the predicted position.

3. The orbit prediction device as set forth in claim 1, wherein:
the error information generation section specifies different error ranges in accordance with the initial position.

4. The orbit prediction device as set forth in claim 1, wherein:
the acquisition section acquires an area-to-mass ratio of the space debris; and
the error information generation section specifies different error ranges in accordance with the area-to-mass ratio.

5. The orbit prediction device as set forth in claim 4, wherein:
the prediction section predicts the position of the space debris after the predetermined time period based on the initial position, the initial velocity, and forces acting on the space debris; and
the error information generation section
changes, in accordance with the area-to-mass ratio, a maximum value A of a force which has not been used for prediction by the prediction section among the forces acting on the space debris, and
calculates the error range using the maximum value A which has been changed.

6. The orbit prediction device as set forth in claim 3, wherein:
the error information generation section decides different error ranges in accordance with a distance between the space debris and a measurement device which has measured the initial position and the initial velocity.

7. The orbit prediction device as set forth in claim 3, wherein:
the error information generation section decides different error ranges in accordance with the initial position with respect to the Earth.

8. An orbit prediction method for causing a computer to carry out:
an acquisition step of acquiring an initial position and an initial velocity of space debris;
a prediction step of, based on the initial position and the initial velocity, predicting a position of the space debris after a predetermined time period; and
an error information generation step of generating information on an error range for a predicted position of the space debris after the predetermined time period.
